(19) United States
(12) Patent Application Publication
(10) Pub. No.: US 2007/0282725 A1
(43) Pub. Date: Dec. 6, 2007

(54) Bank using a tax-advantaged business organization form

(76) Inventor: Andrew M. Murstein, New York, NY (US)

Correspondence Address: SOFER & HAROUN LLP., 317 MADISON AVENUE, SUITE 910, NEW YORK, NY, 10017, US

(21) Appl. No.: 11/786,782

(22) Filed: Apr. 12, 2007

Related U.S. Application Data
(60) Provisional application No. 60/791,517, filed on Apr. 12, 2006.

(51) Int. Cl. G06Q 40/00

(52) U.S. Cl. 705/35; 705/35

(57) ABSTRACT

A method is provided for chartering a family of related companies. The family of related companies includes a bank subsidiary chartered as an industrial loan bank, and chartered and/or operated to provide tax-pass-through treatment for bank earnings to the shareholders of the bank subsidiary. A parent company owns a majority interest, controlling interest in or otherwise controls the bank subsidiary, the parent company's entity form permits corporations to be shareholders. The bank subsidiary and parent company together have or is operated to provide tax-pass-through treatment to the shareholders of the parent company with respect to earnings from the banking operations of the bank subsidiary

### RELATED APPLICATION

This application claims priority from U.S. Provisional Patent Application No. 60/791,517, filed on Apr. 12, 2006, which is incorporated by reference.

### FIELD OF THE INVENTION

This invention relates to finance, arrangements for planning the disposition or use of funds or securities, or extension of credit.

### BACKGROUND

Banks, thrift institutions (“thrifts”) and other lenders are subject to a variety of laws. State and federal authorities promulgate banking laws, and state and federal authorities inspect banks. The Federal Deposit Insurance Corporation (FDIC), Federal Savings and Loan Insurance Corporation (FSLIC), the National Credit Union Administration (NCUA), and other similar federal and state agencies insure depositors' accounts, and require banks to observe certain quality and safety constraints. “Bank(s)” may refer to any institution known to those of ordinary skill in the art as a bank, including but not limited to entities that take deposits on an insured basis (except where the context of this application makes clear that “bank” means “bank” in the more specific sense). Because deposits are insured, banks generally have access to capital at lower cost than other businesses.

Banks pay taxes under the Internal Revenue Code, and issue securities pursuant to the securities laws, like other businesses.

### SUMMARY

In a first aspect, the invention features a family of related companies. The family includes a bank subsidiary and a parent company. The bank subsidiary is chartered as an industrial loan bank subject to state, federal, and/or deposit insurance regulation as a bank, chartered in a state and with conditions qualifying for exemption from the Bank Holding Company Act. This bank subsidiary is chartered as a limited liability company (LLC) is chartered and/or operated to provide tax-pass-through treatment for bank earnings to the shareholders of the bank subsidiary. The parent company owns a majority interest, controlling interest in or otherwise controls the bank subsidiary. The parent company has an entity form, not inherently a tax pass-through form, that qualifies as, and elects to be treated as, a Business Development Company (“BDC”) under the Investment Company Act of 1940 and a Regulated Investment Company (“RIC”) under the Internal Revenue Code. The parent company is exempt from the Bank Holding Company Act. The parent company's entity form permits corporations to be shareholders, to have more than 100 shareholders or members, and to have at least one subchapter C corporation as a shareholder or member. The parent company has shares listed on a public exchange. The bank subsidiary and parent company together have or are operated to provide tax-pass-through treatment for bank earnings to the shareholders of the parent company with respect to the banking operations of the bank subsidiary. The bank subsidiary has consolidated look-through accounting treatment, so assets of the bank subsidiary are accounted for on financial statements of the parent company.

In a second aspect the invention features a family of related companies, including a bank subsidiary and a parent company. The bank subsidiary is chartered as an industrial loan bank, and is chartered and/or operated to provide tax-pass-through treatment for bank earnings to the shareholders of the bank subsidiary. A parent company owns a majority interest, controlling interest in or otherwise controls the bank subsidiary. The parent company's entity form permits corporations to be shareholders. The bank subsidiary and parent company together have or are operated to provide tax-pass-through treatment for bank earnings to the shareholders of the parent company with respect to the banking operations of the bank subsidiary.

In a second aspect, the invention features a family of related companies, including a bank subsidiary and a parent company. The bank subsidiary is chartered to do business as a bank subject to state, federal, and/or deposit insurance regulation as a bank, and is chartered and/or operated to provide tax-pass-through treatment for bank earnings to the shareholders of the bank subsidiary. A parent company owns a majority interest, controlling interest in or otherwise controls the bank subsidiary. The parent company has shares listed on a public exchange. The bank subsidiary and parent together have or are operated to provide tax-pass-through treatment for bank earnings to the shareholders of the parent company with respect to the banking operations of the bank subsidiary.

In another aspect, the invention features a family of related companies. The family includes a bank subsidiary and a parent company. The bank subsidiary company is chartered to do business as a bank, subject to state, federal, and/or deposit insurance regulation as a bank, and is chartered and/or operated to provide tax-pass-through treatment for bank earnings to the shareholders of the bank subsidiary. The parent company owns a majority interest, controlling interest in or otherwise controls the bank subsidiary. The parent company qualifies as, and elects to be treated as a Business Development Company (“BDC”) under the Investment Company Act of 1940 and a Regulated Investment Company (“RIC”) under the Internal Revenue Code. The bank subsidiary and parent together have or are operated to provide tax-pass-through treatment for bank earnings to the shareholders of the parent company with respect to the banking operations of the bank subsidiary.

In another aspect, the invention features a family of related companies including a bank subsidiary and a parent company. The bank subsidiary company is chartered to do business as a bank, subject to state, federal, and/or deposit insurance regulation as a bank, and is chartered and/or operated to provide tax-pass-through treatment for bank earnings to the shareholders of the bank subsidiary. The parent company owns a majority interest, interest in or otherwise controls the bank subsidiary, and is exempt from the Bank Holding Company Act. The bank subsidiary and parent together have or are operated to provide tax-pass-through treatment for bank earnings to the shareholders of the parent company with respect to the banking operations of the bank subsidiary.

Embodiments of the invention may include one or more of the following features. The parent company may not be subject to regulation under the Bank Holding Company Act. The bank subsidiary may be chartered as an industrial loan bank under an entity form, and in a state, and with conditions, qualifying for exemption from the Bank Holding Company Act. The parent company may have an entity from that is not inherently a pass-through form, but may be operated under an elective tax-pass through provision. The parent company may elect treatment as a Business Development Company (a “BDC”) under the Investment Company Act of 1940. The parent company may elect treatment as a Regulated Investment Company (“RIC”) under the Internal Revenue Code. The parent company may be master limited partnership, or a real estate trust. The parent company may have more than 100 shareholders or members and may have at least one subchapter C corporation as a shareholder or member. The bank subsidiary may be a limited liability company. The bank subsidiary may have a consolidated look-through accounting treatment, so assets of the bank subsidiary are accounted for on a financial statements of the parent company.

The above described advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF THE DRAWINGS

FIG. 1 is an entity block diagram; and

FIG. 2 is a flow chart depicting the chartering and tax flow through the entity from FIG. 1.

### DETAILED DESCRIPTION

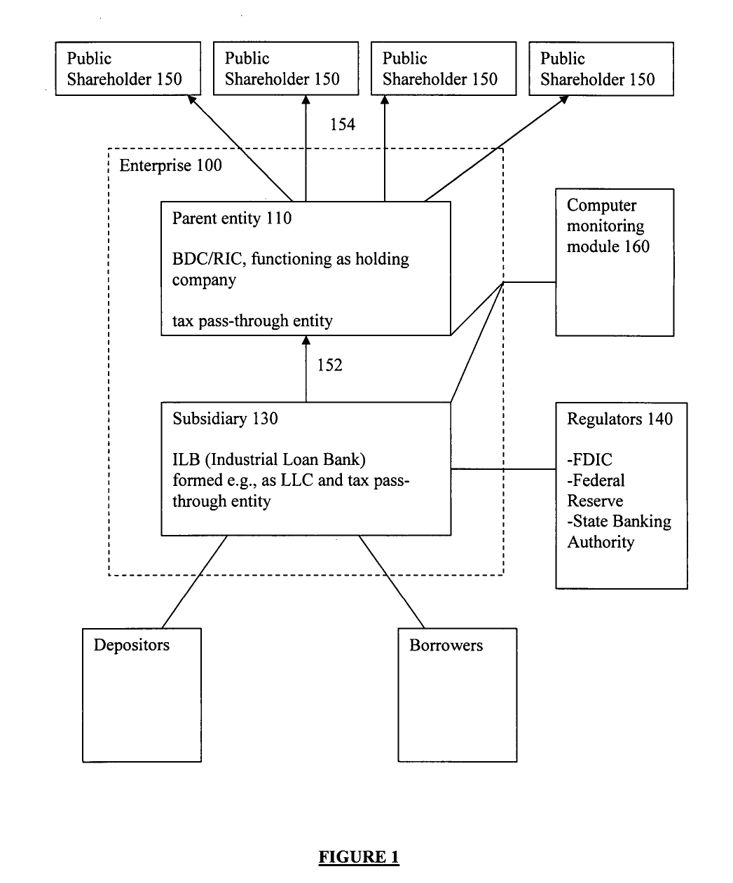

Referring to FIG. 1, enterprise 100 may be an arrangement having one or more business entities 110, 130, where one entity operates as a bank and the other operates as a parent holding company. Entity 130 may act as a bank, taking deposits that are covered by insurance provided by the Federal Deposit Insurance Corporation (FDIC), making loans, and subject to one or more regulators 140.

Enterprise 100 may be permitted to sell equity to a broad class of shareholders 150 (for example, without the limitations imposed on subchapter S corporations, for example the limit on publicly held entities as shareholders), while providing tax-pass through treatment for profits 152, 154 which are passed up to shareholders 150. By carefully designing the forms for the various business entities and observing various business ratios for parent 110 and subsidiary 130 entities, and observing constraints relating to state and federal banking law, securities law, and tax law, earnings 152 on the spread between loans and deposits made by bank entity 130 may be distributed as profits (ultimately arrow 154) to shareholders 150 free of corporate tax on a tax pass-through basis, and thereby provide increased profits to investors 150.

Share ownership in parent entity 110 may be offered broadly to different types of entities, individuals, trusts, estates, corporations, pension funds, mutual funds, etc. (150), increasing the access to capital for both parent entity 110 and bank subsidiary 130. In such an arrangement, parent entity 110 may have access to public capital markets to raise capital in an initial offering, and shares of parent entity 110 may be registered for secondary trading on an exchange, which may increase investment opportunities and liquidity for investors 150. Thus, enterprise 100 is capable of acting as two tiered tax pass-through entity offering banking services (via subsidiary 130) while simultaneously allowing investment from publicly held investors 150 (via parent entity 110).

Enterprise 100 may be arranged as parent entity 110 and bank subsidiary 130. Parent entity 110 may be a Business Development Company (a “BDC”) under the Investment Company Act of 1940 and a Regulated Investment Company (“RIC”) under Subchapter M of the Internal Revenue Code.

Bank subsidiary 130 may be organized as a tax pass-through entity such as a Limited Liability Company (“LLC”), etc. Bank subsidiary 130 may operate as an “industrial loan bank” (ILB) or other bank, thrift or lending institution under the banking laws of any of several states.

Parent entity 110 may be classified as a business development company (BDC). As such, parent entity 110 may be an investment company (as defined under §3(a)(1) of the 1940 Act (15 U.S.C. §80a-3(a)(1)) that has elected to be treated as a Business Development Company (“BDC”).

BDC's are defined by and regulated under §§2(a)(48) and 54 to 65 of the 1940 Act (15 U.S.C. §80a-2(a)(48) and §§80a-53 to 80a-64), and regulations promulgated thereunder (17 C.F.R. Part 275). To meet the definition of a BDC and otherwise meet the requirements of operating as a BDC, parent entity 110 must comply with certain requirements under the statute and regulations, the most relevant of which are summarized informally as follows.

To meet the definition of a BDC as set out under (15 U.S.C. §80a-2(a)(48)), parent entity 110 is a closed end company that: (a) is organized under the laws of, and has its principal place of business in, a state of the United States; (b) is operated for the purpose of making investments in securities enumerated in paragraphs (1) through (3) of Section 55(a) of the 1940 Act (15 U.S.C. §80a-55(a)(1) to (3)); and (c) has elected to be a BDC pursuant to Section 54(a) of the 1940 Act (15 U.S.C. §80a-54(a)). Parent entity 110, in compliance with Section 55 of the 1940 Act (15 U.S.C. §80a-55), may not acquire assets unless, at the time of the acquisition, at least 70% of the assets of parent entity 110 are invested in qualified securities of portfolio companies and cash (the criteria for the securities are specified in 15 U.S.C. §§80a-54). Parent entity 110 offers “significant managerial assistance” to bank subsidiary 130, and provides at least one director to the board of bank subsidiary 130. Parent entity 110 maintains an asset coverage ratio of at least 200% (or a debt-to-equity ratio of no more than 1:1) as required under 15 U.S.C. §80a-60(a)(1), with exemptions as specified in §80a-60(a)(2).

Parent entity 110 may elect to be taxed as a Regulated Investment Company 25 (“RIC”), a classification defined by the Internal Revenue Code at 26 U.S.C. §851-855. To maintain an election as a RIC, parent entity 110 must meet several tests specified by statute and regulations, summarized informally as follows.

Parent entity 110 meets the definition of a BDC. Parent entity 110 arranges to receive at least 90% of its gross income as investment income (dividends, interest, capital gains, and income of similar nature). At least 50% of its assets are represented by cash and securities of portfolio companies, subject to a diversification requirement that no one subsidiary represents more than 25% of the RIC's total assets. Parent entity 110 pays out at least 90% of its earnings (including 152) as dividends 154. So long as parent entity 110 meets all of the requirements of the statutory RIC test, the income 154 distributed to shareholders 150 is not subject to corporate taxation. On the other hand, if parent entity 110 fails to meet some portion of the test, it loses its RIC status, and pays corporate taxes.

In order to maintain RIC status, parent entity 110 pays out 90% of its earnings (including income 152) as dividends (income 154) to shareholders 150 and does not retain significant earnings. Thus, in conjunction with the above identified structure and tax status, paying out dividends provides parent entity 110 concurrently with both tax pass-through treatment and improved access to the capital markets, without, for example, restrictions on share ownership that would limit capital access for a traditional S corporation.

The BDC/RIC structure described above is one example of a structure that achieves some of the tax-pass-through and relaxed shareholder restrictions discussed above. Parent entity 110 may be organized in other ways as well. For example, in various cases, parent entity 110 may be a subchapter C corporation, a Limited Liability Company, a master limited partnership, or real estate investment trust (REIT) structured or operated to avoid payment of corporate taxes. The BDC/RIC structure described above is one such structure.

Parent entity 110 may even be a subchapter S corporation or other entity form that is inherently given tax pass-through treatment, if such entity can be structured so as to avoid the usual restrictions on numerosity or form of shareholders 150.

Turning now to bank subsidiary 130, subsidiary 130 may be structured as a bank, to have a bank's access to low-cost, deposit-insured funding, and may be structured or operated to be a tax-pass-through entity.

Bank subsidiary 130 may be chartered as an “industrial loan bank.” “Industrial loan bank,” “industrial bank,” or “industrial loan corporation” are names for essentially equivalent entities, as provided by the statutes of different states. The terms are used in their industry-standard sense, and except where a distinction between them becomes relevant, the term “industrial loan bank” is herein used to cover all three. In most cases, industrial loan banks are depository institutions chartered under the laws of certain states, including Utah, California, Colorado, Nevada, and Minnesota, and regulated by one of the deposit-insurance agencies, subject to certain limitations. Industrial loan banks are subject to the same banking laws and are regulated, supervised and examined in the same manner as other depository institutions, with certain exceptions. One such exception is specified in 12 U.S.C. §1841(c)(2)(H), which provides that certain “industrial loan companies, industrial banks, or other similar institutions” are exempted from being “banks” within the Bank Holding Company Act. It may be desirable to charter bank subsidiary 130, as an industrial loan bank, to avoid parent entity 110 from being classified as a “bank holding company” under the Bank Holding Company Act (12 U.S.C. §1841 et seq.) in order to reduce regulatory obligations. Industrial Loan Banks are further described in Utah Bankers' Association, Industrial Banks, information pages, such as those available currently through http://www.uba.org/ all of which are incorporated by reference. A paper copy of these documents, obtained from this website, are incorporated by reference; copies may be found in the file of provisional application Ser. No. 60/791,517.

Chartering bank subsidiary 130 as an industrial loan bank permits bank subsidiary 130 to be owned by parent company 110 that is not itself a financial institution, and thus not subject to the Bank Holding Company Act (BHCA). In contrast, ownership of a commercial bank brings a parent company within the BHCA, where the parent company must be a financial institution.

The industrial loan bank charter for bank subsidiary 130 may permit parent entity 110 to engage in non-financial businesses, and to own or invest in businesses or subsidiaries that are not banks and/or that have non-financial operations.

The industrial loan bank charter for bank subsidiary 130 may permit most lines of banking business, including time deposits, certificates of deposit, IRA's, personal and commercial loans, etc . . . , but may limit the ability of bank subsidiary 130 to offer checking accounts once the bank has $100 million or more in assets.

Bank subsidiary 130 may be chartered as an LLC. For example, some states, including Utah, and several regulatory agencies 140, including the FDIC, have recently amended banking laws to permit banks to be chartered as Limited Liability Companies (“LLC”) and/or subchapter S corporations. Subject to certain IRS and deposit-insurance agency regulations and amendments thereto, bank subsidiary 130 may be chartered as a tax-pass-through entity (LLC, S corporation, etc . . . ), and actually receive the tax-pass-through treatment, rather than being subject to taxation as if bank subsidiary 130 were a subchapter C corporation.

Future IRS regulatory changes may permit a bank to be an LLC, a Regulated Investment Company, or other tax-pass-through entity, or may permit a bank S corporation to be owned by a Regulated Investment Company or other parent that can itself act as a tax pass-through.

Turning now to the “asset coverage test,” ownership of bank subsidiary 130 may assist parent entity 110 in meeting the asset coverage test for BDC status in several ways.

First, in some cases, liabilities of bank subsidiary 130 to depositors may not be counted in the asset coverage test, because the liabilities are insured by a deposit-insurance agency, not guaranteed by parent entity 110. Thus, these liabilities may be excluded from the ratio.

Second, in cases where bank subsidiary 130 is consolidated with parent entity 110, the assets of bank subsidiary 130 are counted as part of the asset base of the consolidated entity 100 (rather than the value of the stock of the bank subsidiary 130, which is correlated to the value of assets minus liabilities), and the asset base of the denominator may be substantially increased.

Third, 15 U.S.C. §80a-60(a)(4) exempts certain investments in SBIC's (Small Business Investment Companies) from the asset coverage test. Thus, it may be preferable for bank subsidiary 130 to lend to qualifying small businesses, to allow parent entity 110 to more easily meet the asset coverage test.

Parent entity 110 may be managed such that it falls within the scope of the 70% test of the 1940 Act. For example, a bank would be an “investment company” but for §3(c)(3) of the 1940 Act (15 U.S.C. 80a-3(c)(3)). Entities that fall within §3(c) are not “an eligible portfolio company” within the 70% test of §55(a)(2). Thus, in some cases, enterprise 100 may be managed so that bank subsidiary 130 does not exceed 30% of the assets of BDC parent entity 110, and parent entity 110 may maintain at least 70% of qualifying assets outside bank subsidiary 130. In other cases, so long as corporate formalities between parent entity 110 and bank subsidiary 130 are maintained, the 70% test of §55(a)(2) becomes inapplicable.

Consolidating the financial statements may make it easier for parent entity 110 to meet the tests for BDC and/or RIC status. Recall that the §851 definition of a RIC requires that no more than 25% of the investments of the RIC parent entity 110 to be in any one subsidiary. However, if RIC parent entity 110 and bank subsidiary 130 are eligible for consolidated financial accounting, then bank subsidiary becomes a disregarded look-through entity. Thus, instead of applying the 25% test for the RIC parent entity 110 as

$$\frac{value of bank susbidiary 130}{total value of the parent enterprise entity \text{'} s assets}$$

instead, the test is applied as

$$\frac{value of bank subsidiary 130}{\begin{matrix}total value of the parent enterprise entity \text{'} s assets , counting the \\ bank \text{'} s assets in the parent entity \text{'} s asset base\end{matrix}}$$

Because banks typically lend a large proportion of their assets—thereby creating balance sheet debt—the lower ratio calculation is more easily met than the upper ratio.

Regarding SEC regulatory issues and tax “look through” treatment, regulations of the Securities and Exchange Commission (SEC) have not permitted consolidation of a subsidiary bank's earnings (profit 152 in FIG. 1) and balance sheets into the financial statements of an investment company. However, on a showing that the financial results and financial position of parent entity 110 are more meaningful to an investor if presented as a consolidated whole, as opposed to presenting the results of parent entity 110 as a company that has an investment in bank subsidiary 130, the S.E.C. may permit consolidation for financial accounting purposes, and may issue a no-action letter to that effect.

If the financial statements of bank subsidiary 130 are consolidated with parent entity 110, then the requirement that no subsidiary exceed 25% of the total of the parent RIC's total assets becomes inapplicable with respect to bank subsidiary 130. Once the two entities are consolidated for some purposes, they are not separated for testing compliance with the 25% test.

In order to maintain RIC status for parent entity 110, any subsidiary entities that obtain “look through” treatment may need to exercise care in choosing lines of business to enter, to ensure that their income derives from investment activities compatible with the 90% test for maintaining RIC status for parent entity 110. Thus, a disregarded look-through bank subsidiary 130 may be restricted from non-investment lines of business that are traditionally performed by financial companies, such as servicing of loans for third parties. Such activities may be performed by other subsidiaries that do not claim “look through” status.

As shown in FIG. 1, a computer monitoring module 160 is coupled to parent entity 110, bank subsidiary 130 and enterprise 100 as a whole so that compliance with all of the aforementioned requirements may be monitored. For example, computer monitoring module 160 may be used to monitor that bank subsidiary 130 does not exceed 30% of the asset total of parent entity 110.

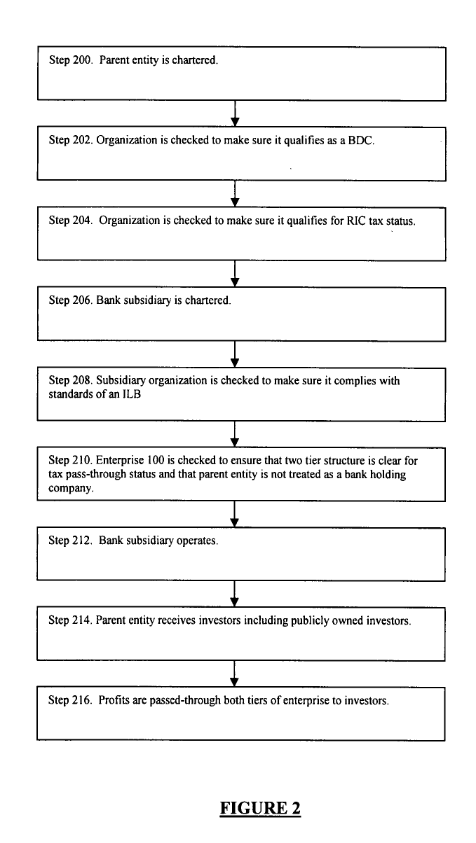

FIG. 2 is an exemplary flow chart for the chartering of enterprise 100 and the related entities. The following description conveys only an exemplary manner in which to charter enterprise 100. However, the timing and various procedures undertaken to generate such an enterprise may occur in any number of various chronological orders, including simultaneously with other steps, and even as continuous processes. Additional steps may be added or steps be removed, provided the resulting enterprise 100 meets the organization form as described in detail above.

In one exemplary embodiment, a first step 200 involves chartering parent company 110. At step 202 parent company 110 may be organized such that its structure qualifies under the relevant laws discussed above, such as a BDC (Business Development Corporation). At step 204, parent company 110 may be further structured such that it qualifies under the relevant tax laws, such as RIC (Regulated Investment Company).

At step 206, the subsidiary bank 130 may be chartered. At step 208, subsidiary bank 130 may be organized such that its structure qualifies under the relevant laws discussed above, such as a ILB (Industrial Loan Bank). At step 210, once subsidiary bank is properly chartered, the structure and organization of enterprise 100 may confirmed such that the organization of bank subsidiary 130 does not cause parent entity 110 to be considered a bank holding company, such as under the Bank Holding Company Act.

In any of the above steps 202, 204, 208 and 210, computer monitoring module 160 may monitor the finances of enterprise 100 electronically such that any financial limits that must be maintained, in order to maintain the appropriate organizational constraints and tax status, can be monitored with notifications sent to the appropriate persons within enterprise 100.

At step 212, subsidiary 130 may begin banking operations. At step 214 parent entity 110 may raise capital from investors/shareholders 150, including public investors. At step 216, profits 152 of bank subsidiary 130 may be passed up to parent entity 110, and in turn passed up (arrow 154) to investors 150. As above, during steps 212-216, computer monitoring module 160 may monitor the finances of enterprise 100 electronically such that any financial limits that must be maintained, in order to maintain the appropriate organizational constraints and tax status.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method, comprising the steps of:
chartering a family of related companies, including at least:
a bank subsidiary chartered as an industrial loan bank subject to state, federal, and/or deposit insurance regulation as a bank, and being chartered and/or operated to provide tax-pass-through treatment for bank earnings to the shareholders of the bank subsidiary, the bank subsidiary being a limited liability company, chartered in a state and with conditions qualifying for exemption from the Bank Holding Company Act; and
a parent company owning a majority interest, controlling interest in or otherwise controlling the bank subsidiary, the parent company having an entity form that is not inherently a tax pass-through entity form, the parent company qualifying as and electing to be treated as a Business Development Company (“BDC”) under the Investment Company Act of 1940 and a Regulated Investment Company (“RIC”) under the Internal Revenue Code, the parent company being exempt from the Bank Holding Company Act, the parent company's entity form permitting corporations to be shareholders, the parent company having more than 100 shareholders or members and having at least one subchapter C corporation as a shareholder or member, the parent company having shares listed on a public exchange;
the bank subsidiary and parent company together having or being operated to provide tax-pass-through treatment to the shareholders of the parent company with respect to earnings from the banking operations of the bank subsidiary, the bank subsidiary having consolidated look-through accounting treatment, so assets of the bank subsidiary are accounted for on financial statements of the parent company.

2. A method, comprising the steps of:
chartering a family of related companies, including at least:
a bank subsidiary chartered as an industrial loan bank subject to state, federal, and/or deposit insurance regulation as a bank, and being chartered and/or operated to provide tax-pass-through treatment for bank earnings to the shareholders of the bank subsidiary; and
a parent company owning a majority interest, controlling interest in or otherwise controlling the bank subsidiary, the parent company qualifying as and electing to be treated as a Business Development Company (“BDC”) under the Investment Company Act of 1940 and a Regulated Investment Company (“RIC”) under the Internal Revenue Code, the parent company being exempt from the Bank Holding Company Act, the parent company's entity form permitting corporations to be shareholders, the parent company having shares listed on a public exchange;
the bank subsidiary and parent company together having or being operated to provide tax-pass-through treatment to the shareholders of the parent company with respect to earnings from the banking operations of the bank subsidiary.

3. A method, comprising the steps of:
chartering a family of related companies, including at least:
a bank subsidiary chartered as an industrial loan bank, and being chartered and/or operated to provide tax-pass-through treatment for bank earnings to the shareholders of the bank subsidiary; and
a parent company owning a majority interest, controlling interest in or otherwise controlling the bank subsidiary, the parent company's entity form permitting corporations to be shareholders;
the bank subsidiary and parent company together having or being operated to provide tax-pass-through treatment to the shareholders of the parent company with respect to earnings from the banking operations of the bank subsidiary.

4. The method of claim 3, wherein the parent company is not subject to regulation under the Bank Holding Company Act.

5. The method of claim 3, wherein the bank subsidiary is chartered as an industrial loan bank.

6. The method of claim 5, wherein the bank subsidiary is chartered as an industrial loan bank under a an entity form, and in a state, and with conditions, qualifying for exemption from the Bank Holding Company Act.

7. The method of claim 3, wherein the parent company is not inherently a pass-through form of entity, but is operated under an elective tax-pass through provision.

8. The method of claim 7, wherein the parent company has elected treatment as a Business Development Company (a “BDC”) under the Investment Company Act of 1940.

9. The method of claim 8, wherein the parent company has elected-treatment as a Regulated Investment Company (“RIC”) under the Internal Revenue Code.

10. The method of claim 3, wherein the parent company is a master limited partnership.

11. The method of claim 3, wherein the parent company is a real estate investment trust.

12. The method of claim 3, wherein the bank subsidiary is a limited liability company.

13. The method of claim 3, wherein the parent company has more than 200 shareholders or members.

14. The method of claim 3, wherein the parent company has at least one subchapter C corporation as a shareholder or member.

15. The method of claim 3, wherein the bank subsidiary has consolidated look-through accounting treatment, so assets of the bank subsidiary are accounted for on financial statements of the parent company.

16. A method, comprising the steps of:
chartering a family of related companies, including at least:
a bank subsidiary company chartered to do business as a bank subject to state, federal, and/or deposit insurance regulation as a bank, and being chartered and/or operated to provide tax-pass-through treatment for bank earnings to the shareholders of the bank subsidiary; and
a parent company owning a majority interest, controlling interest in or otherwise controlling the bank subsidiary, the parent company having shares listed on a public exchange;
the bank subsidiary and parent together having or being operated to provide tax-pass-through treatment to the shareholders of the parent company with respect to earnings from the banking operations of the bank subsidiary.

17. The method of claim 16 wherein the parent company's entity form permits corporations to be shareholders.

18. The method of claim 16, wherein the parent company qualifies as and elects to be treated as a Business Development Company (“BDC”) under the Investment Company Act of 1940 and a Regulated Investment Company (“RIC”) under the Internal Revenue Code.

19. The method of claim 16, wherein the parent company is a master limited partnership.

20. The method of claim 16, wherein the parent company is a real estate investment trust.

21. The method of claim 16, wherein the parent company is not subject to regulation under the Bank Holding Company Act.

22. A method, comprising the steps of:
chartering a family of related companies, including at least:
a bank subsidiary company to do business as a bank, subject to state, federal, and/or deposit insurance regulation as a bank, and being chartered and/or operated to provide tax-pass-through treatment for bank earnings to the shareholders of the bank subsidiary; and
a parent company owning a majority interest, controlling interest in or otherwise controlling the bank subsidiary, the parent company qualifying as and electing to be treated as a Business Development Company (“BDC”) under the Investment Company Act of 1940 and a Regulated Investment Company (“RIC”) under the Internal Revenue Code;
the bank subsidiary and parent together having or being operated to provide tax-pass-through treatment to the shareholders of the parent company with respect to earnings from the banking operations of the bank subsidiary.

23. The method of claim 22, wherein the parent company's entity form permits corporations to be shareholders.

24. The method of claim 22, wherein the parent company is a master limited partnership.

25. The method of claim 22, wherein the parent company is a real estate investment trust.

26. The method of claim 22, wherein the parent company is not subject to regulation under the Bank Holding Company Act.

27. A method, comprising the steps of:
chartering a family of related companies, including at least:
a bank subsidiary company to do business as a bank, subject to state, federal, and/or deposit insurance regulation as a bank, and being chartered and/or operated to provide tax-pass-through treatment for bank earnings to the shareholders of the bank subsidiary; and
a parent company owning a majority interest, controlling interest in or otherwise controlling the bank subsidiary, the parent company being chartered as a master limited partnership or real estate investment trust;
the bank subsidiary and parent together having or being operated to provide tax-pass-through treatment to the shareholders of the parent company with respect to earnings from the banking operations of the bank subsidiary.

28. The method of claim 27, wherein the parent company has elected treatment as a Business Development Company (a “BDC”) under the Investment Company Act of 1940.

29. The method of claim 28, wherein the parent company has elected treatment as a Regulated Investment Company (“RIC”) under the Internal Revenue Code.

30. The method of claim 27, wherein the parent company is not subject to regulation under the Bank Holding Company Act.

31. A method, comprising the steps of:
chartering a family of related companies, including at least:
a bank subsidiary company to do business as a bank, subject to state, federal, and/or deposit insurance regulation as a bank, and being chartered and/or operated to provide tax-pass-through treatment for bank earnings to the shareholders of the bank subsidiary; and
a parent company owning a majority interest, controlling interest in or otherwise controlling the bank subsidiary, the parent company being exempt from the Bank Holding Company Act;
the bank subsidiary and parent together having or being operated to provide tax-pass through treatment to the shareholders of the parent company with respect to earnings from the banking operations of the bank subsidiary.

32. The method of claim 31, wherein the parent company's entity form permits corporations to be shareholders.

33. The method of claim 31, wherein the parent company has elected treatment as a Business Development Company (a “BDC”) under the Investment Company Act of 1940.

34. The method of claim 32, wherein the parent company has elected treatment as a Regulated Investment Company (“RIC”) under the Internal Revenue Code.

35. The method of claim 31, wherein the parent company is a master limited partnership.

36. The method of claim 31, wherein the parent company is a real estate investment trust.

37. A method, comprising the steps of:
chartering a family of related companies, including at least:
a bank subsidiary chartered as an industrial loan bank, and being chartered and/or operated to provide tax-pass-through treatment for bank earnings to the shareholders of the bank subsidiary; and
a parent company owning a majority interest, controlling interest in or otherwise controlling the bank subsidiary, the parent company's entity form permitting corporations to be shareholders;
the bank subsidiary and parent company together having or being operated to provide tax-pass-through treatment to the shareholders of the parent company with respect to earnings from the banking operations of the bank subsidiary;
wherein said chartering step or any of the statuses of the bank subsidiary or parent company are monitored by a computer module for compliance.
